(19) United States
(12) Patent Application Publication
(10) Pub. No.: US 2019/0008182 A1
(43) Pub. Date: Jan. 10, 2019

(54) METHOD OF PREPARING A PROTEIN HYDROLYSATE AND HYDROLYSATE OBTAINED THEREBY

(71) Applicant: ABBOTT LABORATORIES, Abbott Park, IL (US)

(72) Inventors: Laleh LOGHAVI, Dublin, OH (US); Gul KONUKLAR, New Albany, OH (US)

(73) Assignee: Abbott Laboratories, Abbott Park, IL (US)

(21) Appl. No.: 16/067,186

(22) PCT Filed: Dec. 29, 2016
(86) PCT No.: PCT/US2016/069228

§ 371 Date: Jun. 29, 2018

Related U.S. Application Data
(60) Provisional application No. 62/273,721, filed on Dec. 31, 2015.

(51) Int. Cl. A23J 3/34; A23J 3/10; A23J 3/26; A23J 3/18; A23J 3/16; A23J 3/20; A23L 33/18; A23L 33/00

(52) U.S. Cl. CPC A23J 3/344; A23J 3/10; A23J 3/265; A23J 3/18; A23V 2002/00; A23J 3/20; A23J 3/347; A23L 33/18; A23L 33/40; A23J 3/16

(57) ABSTRACT

Abstract: A method of preparing a protein hydrolysate using extrusion technology is provided. An intact protein source and a protease component are added to an extruder and mixed therein to form a slurry including a protein hydrolysate having a degree of hydrolysis of 5% to 30%. The slurry has a total protein content of at least 30% based on the weight of solids in the slurry. A protein hydrolysate accordingly produced is also claimed.

### CROSS-REFERENCE TO RELATED APPLICATIONS

This application claims priority to and the benefit of U.S. Provisional Patent Application No. 62/273,721, filed Dec. 31, 2015, the entire content of which is incorporated by reference herein.

### FIELD

The present disclosure relates to a method of preparing a protein hydrolysate. More particularly, the present disclosure relates to a method of preparing a protein hydrolysate using extrusion technology.

### BACKGROUND

Protein hydrolysates are commonly used in various nutritional products and supplements. For example, certain infant formulas and muscle enhancing supplements use protein hydrolysates because the protein hydrolysates are partially pre-digested and more easily absorbed as compared to intact protein. Conventional methods of manufacturing protein hydrolysates typically use batch processes wherein a protein-containing material is contacted with enzymes to catalyze the hydrolysis of the protein in the protein-containing material. However, protein hydrolysis via a batch process can require up to fourteen hours of processing time. Moreover, batch processes for conducting protein hydrolysis reactions typically require a high water content (e.g., greater than 75%) and a low total solids content (e.g., less than 25%), which slows the rate of diffusion of the enzymes for catalyzing the hydrolysis of the protein. Based on the low total solids content required in batch processing, the amount of protein in the slurry of a batch process is only about 8-18% based on the weight of solids in the slurry.

### SUMMARY

Disclosed herein is a method of preparing a protein hydrolysate using extrusion technology. To illustrate various aspects of the present disclosure, several exemplary embodiments of the method are provided herein.

In one exemplary embodiment, a method of preparing a protein hydrolysate is provided. The method includes adding an intact protein source and a protease component to an extruder. The intact protein source and the protease component are mixed within the extruder to form a slurry comprising a protein hydrolysate. The protein hydrolysate has a degree of hydrolysis of 5% to 30%. The slurry has a total protein content of at least 30% based on the weight of solids in the slurry.

In certain exemplary embodiments, water is added to the extruder along with the intact protein source and the protease component. In certain exemplary embodiments, the intact protein source and the protease component are added to the extruder in amounts such that a weight ratio of active protease to protein is from 0.8:100 to 8:100. In certain exemplary embodiments, a pH adjuster is added to the extruder to maintain a pH of the slurry at from 5 to 9.

In certain exemplary embodiments, the contents of the extruder are heated to a temperature of 20° C. to 75° C. to promote hydrolysis of the intact protein source. In certain exemplary embodiments, the slurry is heated to a temperature of from 80° C. to 105° C. to promote inactivation of the protease component in the slurry.

In certain exemplary embodiments, the intact protein source comprises a dairy protein. In certain exemplary embodiments, the intact protein source comprises a non-dairy protein.

In one exemplary embodiment, a method of preparing a protein hydrolysate is provided. The method includes adding an intact protein source in powder form into one or more inlets of an extruder, adding a protease component into one or more inlets of the extruder, adding water into one or more inlets of the extruder, and adding a pH adjuster into one or more inlets of the extruder. The intact protein source, the protease component, water, and the pH adjuster are mixed within the extruder to form a slurry comprising a protein hydrolysate having a degree of hydrolysis of 5% to 30%. The slurry has a total protein content of at least 30% based on the weight of solids in the slurry. In certain exemplary embodiments, the intact protein source and the protease component are added to the extruder in amounts such that a weight ratio of active protease to protein is from 0.8:100 to 8:100.

### BRIEF DESCRIPTION OF THE DRAWINGS

FIG. 1 is a schematic diagram of an embodiment of a method of preparing a protein hydrolysate as described herein.

FIG. 2 is a schematic diagram of an embodiment of a method of preparing a protein hydrolysate as described herein.

FIG. 3 is a schematic diagram of an embodiment of a method of preparing a protein hydrolysate as described herein.

### DETAILED DESCRIPTION

Disclosed herein are methods of preparing a protein hydrolysate using extrusion technology. While the present disclosure describes certain embodiments of the methods in detail, the present disclosure is to be considered exemplary and is not intended to be limited to the disclosed embodiments.

The terminology as set forth herein is for description of the embodiments only and should not be construed as limiting the disclosure as a whole. All references to singular characteristics or limitations of the present disclosure shall include the corresponding plural characteristic or limitation, and vice versa, unless otherwise specified or clearly implied to the contrary by the context in which the reference is made. Unless otherwise specified, “a,” “an,” “the,” and “at least one” are used interchangeably. Furthermore, as used in the description and the appended claims, the singular forms “a,” “an,” and “the” are inclusive of their plural forms, unless the context clearly indicates otherwise.

The methods of preparing a protein hydrolysate as described in the present disclosure can comprise, consist of, or consist essentially of the essential elements of the disclosure as described herein, as well as any additional or optional element described herein or which is otherwise useful in extrusion related processes.

All percentages, parts, and ratios as used herein are by weight of the total formulation, unless otherwise specified. All such weights as they pertain to listed ingredients are based on the active level and, therefore, do not include solvents or by-products that may be included in commercially available materials, unless otherwise specified.

All ranges and parameters, including but not limited to percentages, parts, and ratios, disclosed herein are understood to encompass any and all sub-ranges assumed and subsumed therein, and every number between the endpoints. For example, a stated range of “1 to 10” should be considered to include any and all sub-ranges beginning with a minimum value of 1 or more and ending with a maximum value of 10 or less (e.g., 1 to 6.1, or 2.3 to 9.4), and to each integer (1, 2, 3, 4, 5, 6, 7, 8, 9, and 10) contained within the range.

Any combination of method or process steps as used herein may be performed in any order, unless otherwise specified or clearly implied to the contrary by the context in which the referenced combination is made.

The term “active protease” as used herein, unless otherwise specified, refers to the portion of the protease component that exhibits protease activity. For example, a protease component in liquid form may only contain from about 9% to about 17% active protease by weight of the protease component, with the remainder of the protease component comprising solvent, preservatives, stabilizers, and the like.

The term “pH adjuster” as used herein, unless otherwise specified, refers to a component that can change the pH of a mixture, or a component that when added to a mixture can resist a change to the pH. Exemplary pH adjusters include acids, bases, buffers, and combinations thereof.

The exemplary embodiments of the method of preparing a protein hydrolysate described herein utilize an extruder. Any suitable extruder known for use in the nutritional arts may be used in accordance with the embodiments of the method of the present disclosure. For example, in certain exemplary embodiments, the extruder may be a single screw extruder, multi screw extruder, ring screw extruder, planetary gear extruder, and the like.

In certain exemplary embodiments, the method of preparing a protein hydrolysate uses a co-rotating, twin screw extruder. Generally, twin screw extruders comprise a barrel having one or more inlets for adding ingredients, two screws, and a die or other outlet. The extruder screws are positioned inside of the barrel and may comprise a wide variety of functional elements including, but not limited to, shear elements, mixing elements, homogenizing elements, conveying elements, reverse elements, kneading elements, emulsifying elements, disc elements, or any combination of the foregoing in any interchangeable order. The barrel of the extruder may comprise a number of segments that are bolted, clamped, or otherwise joined together. The barrel or barrel segments may be jacketed to permit indirect, controlled heating or cooling of the material being processed within the extruder. In addition, the barrel or barrel segments may include one or more inlets for adding ingredients into the extruder. The extruder also includes one or more outlets (e.g., a die) to allow the material within the extruder to flow out of the extruder.

The use of an extruder in the exemplary methods of preparing a protein hydrolysate disclosed herein has several advantages over conventional batch processes used to prepare protein hydrolysates. For example, the extruder can mix together the ingredients that form the protein hydrolysate at a much higher solids level, which increases the amount of protein hydrolysate produced. Based on the ability of the extruder to handle a higher solids level, throughput is increased within the extruder as compared to conventional processes for preparing a protein hydrolysate. Moreover, the high shear rate that can be achieved in an extruder, along with the high solids level, provides an opportunity for increased diffusion rates of the enzyme for catalyzing the hydrolysis of the protein. In addition, the extruder allows for increased automation, which enables greater process control. Furthermore, the extruder can reduce the microbial load of the protein hydrolysate product due to the heat and shear generated within the extruder.

In one exemplary embodiment, a method of preparing a protein hydrolysate comprises adding an intact protein source and a protease component to an extruder. The intact protein source and the protease component are mixed within the extruder, wherein a slurry is formed and the intact protein source is hydrolyzed such that the slurry comprises a protein hydrolysate having a degree of hydrolysis of 5% to 30%. The slurry has a total protein content of at least 30% based on the weight of solids in the slurry.

In certain embodiments, the intact protein source added to the extruder is in powder form. The intact protein source in powder form may be added to the extruder by a variety of techniques including, but not limited to, gravity feeding from a hopper, pumping from a storage tank, and the like. In some embodiments, the intact protein source added to the extruder is in the form of an aqueous protein suspension. For example, the intact protein source may be mixed with water and the resulting aqueous protein suspension may be pumped into the extruder from a storage tank or other vessel. In certain embodiments, the aqueous protein suspension may be subjected to a heat treatment, a filtration process, such as a microfiltration process or an ultrafiltration process, or both a heat treatment and a filtration process prior to being added to the extruder.

In certain embodiments, the intact protein source, whether in powder form or aqueous suspension form, is added into one or more inlets of the extruder. The term “inlet” as used herein refers to an opening on the extruder through which material can be introduced into the extruder. An inlet of the extruder may be positioned anywhere along the length of the extruder. In certain embodiments, the intact protein source is added to the extruder through an inlet positioned within the first quarter of the length of the extruder. In certain embodiments, the extruder is a multi-barrel extruder and the intact protein source is added to the multi-barrel extruder through an inlet positioned on the first barrel of the multi-barrel extruder.

A wide variety of proteins may be used as the intact protein source in the exemplary methods described herein. In certain embodiments, the intact protein source comprises a dairy protein. Exemplary dairy proteins suitable for use in the exemplary methods disclosed herein include, but are not limited to, whey protein concentrate, whey protein isolate, acid casein, rennet casein, sodium caseinate, calcium caseinate, potassium caseinate, milk protein concentrate, milk protein isolate, non-fat dry milk, and combinations thereof. In certain embodiments, the intact protein source comprises a non-dairy protein. Exemplary non-dairy proteins suitable for use in the exemplary methods disclosed herein include, but are not limited to, soy protein concentrate, soy protein isolate, pea protein concentrate, pea protein isolate, rice protein concentrate, rice protein isolate, potato protein concentrate, potato protein isolate, algal protein concentrate, algal protein isolate, corn protein concentrate, corn protein isolate, wheat protein concentrate, wheat protein isolate, oat protein concentrate, oat protein isolate, canola protein concentrate, canola protein isolate, sunflower protein concentrate, sunflower protein isolate, soy flour, peanut flour, and combinations thereof.

To catalyze the hydrolysis reaction of the intact protein source, a protease component is added to the extruder. Generally, proteases are commercially available in liquid form or powder form. In certain embodiments, the protease component added to the extruder is in liquid form and may be added to the extruder, for example, by pumping the protease component into the extruder from a storage tank or other vessel. In certain embodiments, the protease component added to the extruder is in powder form. The protease component in powder form may be added to the extruder by a variety of techniques including, but not limited to, gravity feeding from a hopper, pumping from a storage tank, and the like.

In certain embodiments, the protease component, whether in liquid or powder form, is added into one or more inlets of the extruder. In certain embodiments, the protease component is added to the extruder through an inlet positioned within the first half of the length of the extruder. In certain embodiments, the protease component is added to the extruder through an inlet positioned within the first quarter of the length of the extruder. It is also contemplated that a liquid protease component and a powder protease component may be added to the extruder through one or more inlets of the extruder either separately or together.

A wide variety of proteases may be used as the protease component in the exemplary methods described herein. Proteases may be classified by the source organism, the active pH range, the peptide bond specificity, and so forth. For example, a protease may be derived from certain bacteria or fungi; exhibit greater activity at an acidic pH, a neutral pH, or an alkaline pH; and may function as an endopeptidase, an exopeptidase, an amino acid specific protease, or combinations thereof. Any protease suitable for use in the food industry may be used as the protease component in the exemplary methods described herein. In certain embodiments, the protease component comprises a protease derived from Bacillus licheniformis. An exemplary commercially available protease derived from Bacillus licheniformis is Alcalase 2.4L from Novozyme A/S (Bagsvaerd, Denmark). In certain embodiments, the protease component comprises a protease derived from Aspergillus oryzae. An exemplary commercially available protease derived from Aspergillus oryzae is Flavourzyme 1000L from Novozyme A/S (Bagsvaerd, Denmark). In certain embodiments, the protease component comprises a mixture of proteases, for example a mixture of a protease derived from Bacillus licheniformis and a protease derived from Aspergillus oryzae. In certain other embodiments, different protease components may be added to the extruder through one or more inlets of the extruder either separately or together.

After the intact protein source and the protease component are added to the extruder, the intact protein source and the protease component are mixed within the extruder to form a slurry. As the intact protein source and the protease component are mixed together, the protease component catalyzes the hydrolysis reaction of the intact protein source such that the slurry formed within the extruder comprises a protein hydrolysate having a degree of hydrolysis of 5% to 30%. In certain embodiments, the protein hydrolysate has a degree of hydrolysis of from 8% to 30%, including from 10% to 28%, from 13% to 25%, from 15% to 25%, from 15% to 20%, and also including from 5% to 15%.

In accordance with the exemplary methods disclosed herein, the slurry exiting the extruder has a total protein content of at least 30% based on the weight of solids in the slurry. In certain embodiments, the slurry comprises from 30% to 70% by weight solids, including from 30% to 65%, from 30% to 60%, from 30% to 55%, from 30% to 50%, from 35% to 45%, or from 40% to 60% by weight solids. In general, the slurry exiting the extruder is a paste-like mixture. As previously mentioned, one advantage of the exemplary methods disclosed herein is that the hydrolysis reaction performed in the extruder can be carried out at a much higher solids level as compared to conventional batch processes, which are typically carried out at a 10% by weight solids level. By increasing the solids level of the slurry, more protein hydrolysate can be produced.

The total protein content of the slurry exiting the extruder will typically depend on the amount of protein contained in the intact protein source. For example, a whey protein concentrate powder used as the intact protein source may comprise 30% protein by weight of the powder, or a soy protein isolate powder used as the intact protein source may comprise 80% protein by weight of the powder. In certain embodiments, the intact protein source used in the method comprises a dairy protein, and the slurry has a total protein content of from 30% to 90% based on the weight of solids in the slurry, including from 35% to 90%, from 40% to 85%, from 40% to 75%, from 45% to 65%, and also including a total protein content of from 50% to 90% based on the weight of solids in the slurry. Any one or more of the dairy proteins previously mentioned may be used to achieve the total protein content. In certain embodiments, the intact protein source used in the method comprises a non-dairy protein, and the slurry has a total protein content of from 40% to 85% based on the weight of solids in the slurry, including from 45% to 85%, from 50% to 80%, from 55% to 80%, and also including a total protein content of from 60% to 85% based on the weight of solids in the slurry. Any one or more of the non-dairy proteins previously mentioned may be used to achieve the total protein content.

In certain embodiments, water is added into one or more inlets of the extruder. The water hydrates the intact protein source (when in powder form) and acts as a reactant and a solvent to facilitate the hydrolysis of the intact protein source. The water may also be used to control the solids content of the slurry comprising the protein hydrolysate exiting the extruder. In certain embodiments, the water is added to the extruder through an inlet positioned within the first half of the length of the extruder. In certain embodiments, the water is added to the extruder through an inlet positioned within the first quarter of the length of the extruder. The water may be added to the extruder, for example, by pumping the water from a storage tank or other vessel. In certain embodiments, the water added to the extruder may be at a temperature of from 20° C. to 75° C. Full hydration of the components added to the extruder ensure that the extruder will operate properly and that the slurry comprising the protein hydrolysate exiting the extruder is fully mixed with no pockets of powder material contained therein. Those skilled in the art will understand that incomplete hydration of the components added to the extruder can cause the extruder to malfunction due to high levels of torque and produce a slurry that contains residual powder material. Accordingly, incomplete hydration of the components added to the extruder should be avoided to ensure proper extruder operation and an acceptable protein hydrolysate product.

To facilitate pH control of the contents of the extruder, in certain embodiments of the method disclosed herein, a pH adjuster may be added to the extruder. The pH of the contents of the extruder is a parameter that can affect the hydrolysis of the intact protein source since the protease component will have an optimal pH range for facilitating catalysis of the hydrolysis reaction. As the intact protein source is hydrolyzed within the extruder, the pH of the contents of the extruder may change to a pH that is outside of the optimal pH range for the protease component. Accordingly, in certain embodiments of the methods disclosed herein, a pH adjuster is added into one or more inlets of the extruder to maintain the pH of the contents of the extruder within the optimal pH range of the protease component. In certain embodiments, the pH adjuster is added to the extruder through an inlet positioned within the first three-quarters of the length of the extruder. In certain embodiments, the pH adjuster is added to the extruder through an inlet positioned within the first half of the length of the extruder. In certain embodiments, the pH adjuster is added to the extruder through an inlet positioned within the first quarter of the length of the extruder. In certain embodiments, the pH adjuster is added to the extruder in at least two separate inlets of the extruder. For example, in one embodiment, a first pH adjuster is added to the extruder through an inlet positioned within the first quarter of the length of the extruder, and a second pH adjuster, which may be the same or different than the first pH adjuster, is added to the extruder through an inlet positioned within the second quarter of the length of the extruder. The pH adjuster may be in liquid form or powder form, and may be added to the extruder, for example, by pumping the pH adjuster, when in liquid form, from a storage tank or other vessel, or by gravity feeding the pH adjuster, when in powder form, from a hopper or other powder storage means.

The pH adjuster added to the extruder may be an acid, a base, a buffer, and combinations thereof. Any food grade acid, base, buffer, and combinations thereof may be used in the exemplary methods disclosed herein. For example, in certain embodiments, a potassium hydroxide solution may be added to the extruder to raise the pH of the contents of the extruder to be within the optimal pH range of the protease component. In other embodiments, a hydrochloric acid solution may be added to the extruder to lower the pH of the contents of the extruder to be within the optimal pH range of the protease component. To achieve the optimal pH range of the protease component, the addition of the pH adjuster may be calibrated or controlled with a pH sensing system (e.g., pH-stat) that is in contact with the contents of the extruder.

The mixing of the contents of the extruder may be carried out at various temperatures. The temperature of the contents of the extruder is another parameter that can affect the hydrolysis of the intact protein source since the protease component will have an optimal temperature range for facilitating catalysis of the hydrolysis reaction. In certain embodiments, the methods disclosed herein comprise controlling the temperature of the contents of the extruder. For example, in certain embodiments, the methods disclosed herein comprise heating the contents of the extruder to a temperature of from 20° C. to 75° C., including from 30° C. to 75° C., from 40° C. to 75° C., from 45° C. to 70° C., from 50° C. to 65° C., and also including from 50° C. to 60° C. In certain embodiments, the methods disclosed herein comprise cooling the contents of the extruder to a temperature of from 20° C. to 75° C., including from 30° C. to 75° C., from 40° C. to 75° C., from 45° C. to 70° C., from 50° C. to 65° C., and also including from 50° C. to 60° C. In certain other embodiments, the methods disclosed herein comprise heating and cooling the contents of the extruder to maintain a temperature of from 20° C. to 75° C., including from 30° C. to 75° C., from 40° C. to 75° C., from 45° C. to 70° C., from 50° C. to 65° C., and also including from 50° C. to 60° C. As previously mentioned, the barrel or barrel segments of the extruder may be jacketed to permit indirect, controlled heating (e.g., by steam) or cooling (e.g., by cooling water) of the contents within the extruder. By way of example only, a first barrel of the extruder may be configured to maintain a temperature of 25° C., a second barrel of the extruder may be configured to maintain a temperature of 60° C., a third barrel of the extruder may be configured to maintain a temperature of 70° C., and so forth.

In certain embodiments of the methods disclosed herein, the protease component in the slurry is inactivated within the extruder. Inactivation of the protease component may be accomplished by heating the slurry to a temperature that will denature the protease component. In certain embodiments, the exemplary methods disclosed herein further comprise heating the slurry to a temperature of from 80° C. to 105° C., including from 80° C. to 100° C., from 85° C. to 95° C., from 85° C. to 90° C., and also including from 95° C. to 100° C. to promote inactivation of the protease component. In certain embodiments, the final quarter length of the extruder is configured to control the temperature of the slurry at from 80° C. to 105° C., including from 80° C. to 100° C., from 85° C. to 95° C., from 85° C. to 90° C., and also including from 95° C. to 100° C. to promote inactivation of the protease component. In certain embodiments, the slurry is heated to a temperature of from 80° C. to 105° C., including from 80° C. to 100° C., from 85° C. to 95° C., from 85° C. to 90° C., and also including from 95° C. to 100° C. for a time period of 30 seconds to 10 minutes, including from 1 minute to 8 minutes, from 1 minute to 6 minutes, from 1 minute to 5 minutes, from 2 minutes to 4 minutes, and also including from 5 minutes to 10 minutes to promote inactivation of the protease component.

In certain embodiments of the methods disclosed herein, the protease component in the slurry is inactivated outside of the extruder. In certain embodiments, the exemplary methods disclosed herein further comprise heating the slurry after it has exited the extruder to a temperature of from 80° C. to 105° C., including from 80° C. to 100° C., from 85° C. to 95° C., from 85° C. to 90° C., and also including from 95° C. to 100° C. for a time period of 30 seconds to 10 minutes, including from 1 minute to 8 minutes, from 1 minute to 6 minutes, from 1 minute to 5 minutes, from 2 minutes to 4 minutes, and also including from 5 minutes to 10 minutes to promote inactivation of the protease component. In certain embodiments of the methods disclosed here, the slurry exits the extruder and enters a hold tube in which the slurry is heated to a temperature of from 80° C. to 105° C., including from 80° C. to 100° C., from 85° C. to 95° C., from 85° C. to 90° C., and also including from 95° C. to 100° C. for a time period of 30 seconds to 10 minutes, including from 1 minute to 8 minutes, from 1 minute to 6 minutes, from 1 minute to 5 minutes, from 2 minutes to 4 minutes, and also including from 5 minutes to 10 minutes to promote inactivation of the protease component.

The processing of the various components added to the extruder to prepare the protein hydrolysate according to the exemplary methods disclosed herein may be carried out at various residence times. As previously mentioned, one advantage of the exemplary methods disclosed herein is that the time required to prepare the protein hydrolysate is considerably less than the time required to prepare protein hydrolysate using conventional batch processes. In certain embodiments of the methods disclosed herein, the components added to the extruder are processed within the extruder for 2 minutes to 60 minutes, including from 2 minutes to 45 minutes, from 5 minutes to about 30 minutes, from 5 minutes to 25 minutes, from 10 minutes to 20 minutes, from 5 minutes to about 20 minutes, or from 2 minutes to 10 minutes to prepare the protein hydrolysate.

Another parameter that can affect the hydrolysis of the intact protein source within the extruder is the weight ratio of active protease to protein. As previously mentioned, the amount of active protease in a particular protease component can vary depending on whether the protease component is in liquid form or in powder or other solid form. Similarly, the amount of protein in a particular intact protein source can vary widely. For example, the amount of protein in a particular whey protein concentrate powder may contain about 30% protein by weight of the powder, with the remainder of the powder comprising carbohydrates, fats, minerals, and the like. In certain embodiments of the methods disclosed herein, the intact protein source and the protease component are added to the extruder in amounts such that a weight ratio of active protease to protein is from 0.8:100 to 8:100, including from 0.9:100 to 7:100, from 1:100 to 6:100, and also including from 2:100 to 5:100. It has been found that a weight ratio of active protease to protein of from 0.8:100 to 8:100 can be used in the exemplary methods disclosed herein to prepare a protein hydrolysate having a degree of hydrolysis of 5% to 30%.

In another exemplary embodiment, a method of preparing a protein hydrolysate comprises adding an intact protein source in powder form into one or more inlets of an extruder, adding a protease component into one or more inlets of the extruder, adding water into one or more inlets of the extruder, and adding a pH adjuster into one or more inlets of the extruder. The intact protein source, the protease component, the water, and the pH adjuster are mixed within the extruder, wherein a slurry is formed and the intact protein source is hydrolyzed such that the slurry comprises a protein hydrolysate having a degree of hydrolysis of 5% to 30%. The slurry has a total protein content of at least 30% based on the weight of solids in the slurry. Any one or more of the intact protein sources, the protease components, and the pH adjusters previously described may be used in this exemplary method. Any of the previously described processing conditions or parameters (e.g., pH, temperature, weight ratio of active protease to protein, slurry solids content, residence time) may apply equally to this exemplary method.

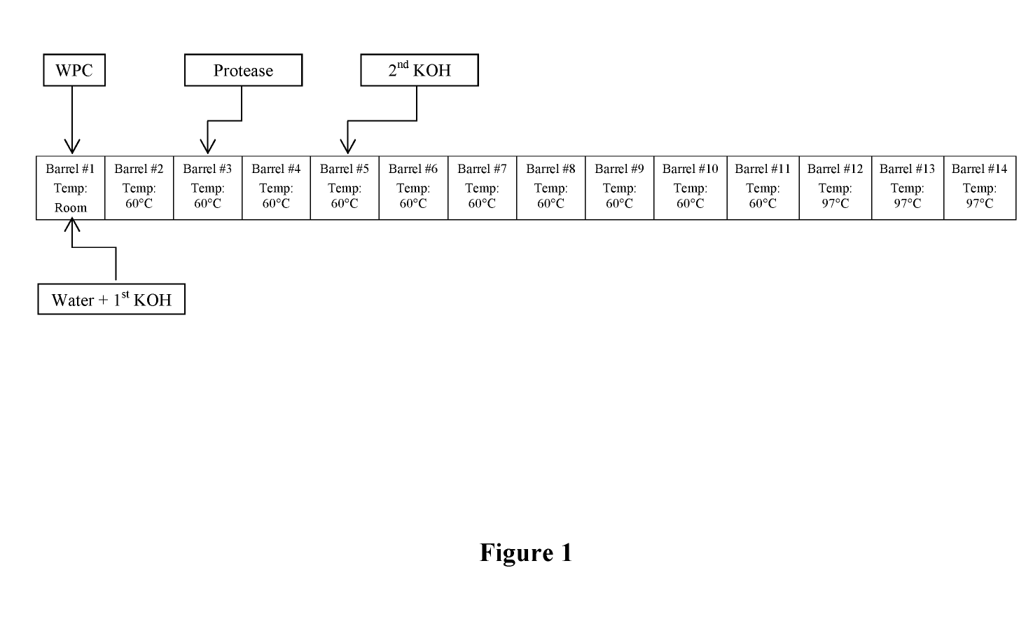

Referring now to FIG. 1, an exemplary embodiment of a method for preparing a protein hydrolysate within an extruder is shown in schematic form. In this exemplary embodiment, an intact protein source in powder form (whey protein concentrate) (WPC) and water and a first 1 N KOH solution (Water+1st KOH) are added to the first barrel of a fourteen barrel twin-screw extruder. The first barrel is maintained at room temperature (e.g., 20° C. to 25° C.). A protease component (Protease) is added to the third barrel of the extruder. The WPC, water, 1st KOH, and the protease are mixed within the extruder and react to form a slurry comprising a protein hydrolysate. As the slurry is further mixed and conveyed within the extruder, a second 1 N KOH solution (2nd KOH) is added to the fifth barrel of the extruder to adjust the pH of the slurry to promote the hydrolysis reaction. The temperatures of the second barrel through the eleventh barrel of the extruder are maintained at approximately 60° C. The temperatures of the twelfth barrel through the fourteenth barrel are maintained at approximately 97° C. to promote inactivation of the protease. The slurry exiting the extruder comprises protein hydrolysate and may be processed, for example, by drying the slurry to produce a powder protein hydrolysate, or collected and stored in a product storage vessel for processing at a later time.

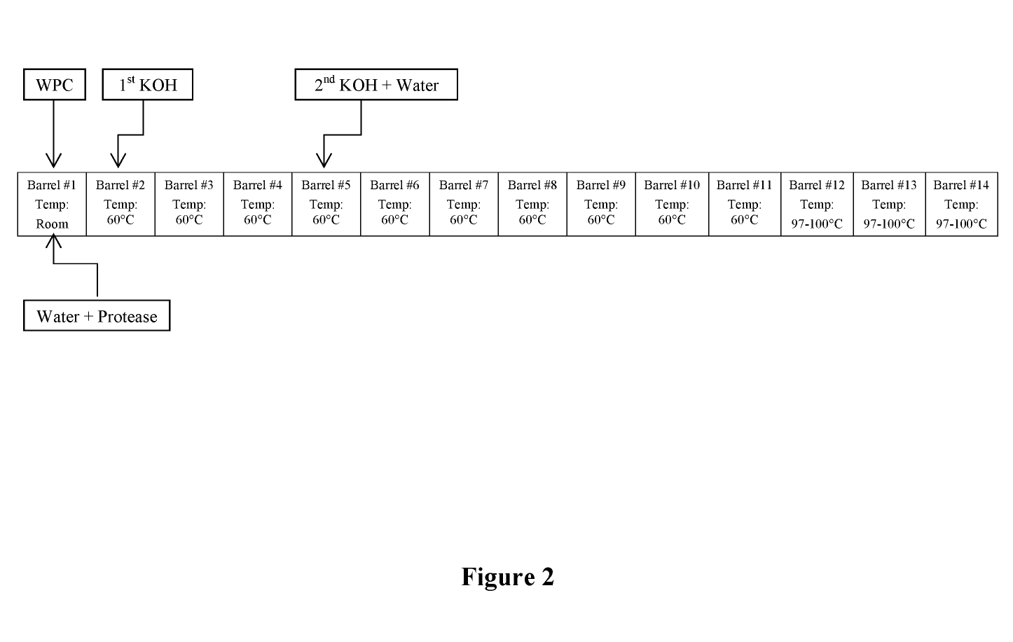

With reference now to FIG. 2, an additional exemplary embodiment of a method for preparing a protein hydrolysate within an extruder is shown in schematic form. In this exemplary embodiment, an intact protein source in powder form (whey protein concentrate) (WPC) and water and a protease component (Water+Protease) are added to the first barrel of a fourteen barrel twin-screw extruder and are mixed within the extruder and react to form a slurry comprising a protein hydrolysate. The first barrel is maintained at room temperature (e.g., 20° C. to 25° C.). A first 1 N KOH solution (1st KOH) is added to the second barrel of the extruder to adjust the pH of the slurry to promote the hydrolysis reaction. As the slurry is further mixed and conveyed within the extruder, a second 1 N KOH solution and water (2nd KOH+Water) is added to the fifth barrel of the extruder to adjust the pH of the slurry to promote the hydrolysis reaction. The temperatures of the second barrel through the eleventh barrel of the extruder are maintained at approximately 60° C. The temperatures of the twelfth barrel through the fourteenth barrel are maintained at approximately 97° C. to 100° C. to promote inactivation of the protease. The slurry exiting the extruder comprises protein hydrolysate and may be processed, for example, by drying the slurry to produce a powder protein hydrolysate, or collected and stored in a product storage vessel for processing at a later time.

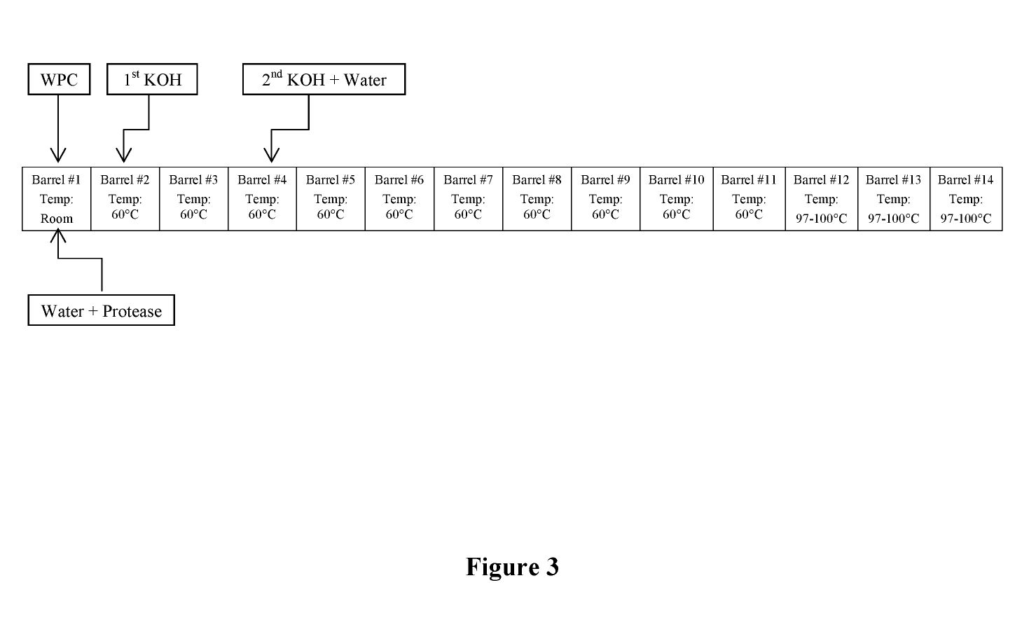

Referring now to FIG. 3, yet another embodiment of an exemplary method for preparing a protein hydrolysate within an extruder is shown in schematic form. In this exemplary embodiment, an intact protein source in powder form (whey protein concentrate) (WPC) and water and a protease component (Water+Protease) are added to the first barrel of a fourteen barrel twin-screw extruder and are mixed within the extruder and react to form a slurry comprising a protein hydrolysate. The first barrel is maintained at room temperature (e.g., 20° C. to 25° C.). A first 1 N KOH solution (1st KOH) is added to the second barrel of the extruder to adjust the pH of the slurry to promote the hydrolysis reaction. As the slurry is further mixed and conveyed within the extruder, a second 1 N KOH solution and water (2nd KOH+water) is added to the fourth barrel of the extruder to adjust the pH of the slurry to promote the hydrolysis reaction. The temperatures of the second barrel through the eleventh barrel of the extruder are maintained at approximately 60° C. The temperatures of the twelfth barrel through the fourteenth barrel are maintained at approximately 97° C. to 100° C. to promote inactivation of the protease. The slurry exiting the extruder comprises protein hydrolysate and may be processed, for example, by drying the slurry to produce a powder protein hydrolysate, or collected and stored in a product storage vessel for processing at a later time.

In one exemplary embodiment, a protein hydrolysate prepared according to any one of the exemplary methods described herein is provided. The protein hydrolysates prepared according to the methods described herein have a degree of hydrolysis of from 5% to 30%. The degree of hydrolysis is the extent to which peptide bonds are broken by the hydrolysis reaction. The degree of hydrolysis may be determined by quantifying the amino nitrogen to total nitrogen ratio (AN/TN) of the protein. The amino nitrogen component is quantified by USP titration methods for determining amino nitrogen content, while the total nitrogen component is determined by the Tecator® Kjeldahl method. These analytical methods are well known.

The exemplary methods of preparing a protein hydrolysates as described herein may reduce the microbial load in the slurry to a desired amount or for a desired end application. The reduction in microbial load is achieved by the heat and shear generated during the processing of the contents within the extruder.

The protein hydrolysates prepared in accordance with the methods described herein may be used as a commodity ingredient in nutritional formulations such as infant formulas, nutritional liquids, and nutritional powders. In certain embodiments, the slurry comprising the protein hydrolysate exiting the extruder is dried, for example by spray drying, to produce a protein hydrolysate powder.

### EXAMPLE

The following example illustrates specific exemplary embodiments and features of the methods of preparing a protein hydrolysate as disclosed herein. The example is given solely for the purpose of illustration and is not to be construed as limiting the present disclosure, as many variations thereof are possible without departing from the spirit and scope of the disclosure.

This example illustrates exemplary methods of preparing a protein hydrolysate as disclosed herein. The processing equipment used to prepare the protein hydrolysate in this example included a 14-barrel twin-screw extruder coupled with one powder feeder and three liquid feeders. At the startup of each trial, the intact protein source in powder form was added gradually to avoid powder build up in the extruder. The extruder was operated at 120 revolutions per minute (RPM) in every trial. A total of 10 trials were conducted to prepare protein hydrolysate at various solids levels.

Trial 1—The particular equipment set up used to conduct trial 1 is illustrated schematically in FIG. 1. In trial 1, a whey protein concentrate (WPC) powder containing about 6% moisture by weight of the powder and about 76% protein by weight of the solids content of the powder was used as the intact protein source. The protease component used in trial 1 was Aclalase 2.4L (Novozyme A/S, Bagsvaerd, Denmark), which is a liquid product that contains about 9% active protease by weight of the liquid. Water and 1N KOH solutions were also used in trial 1.

In trial 1, the WPC powder and a mixture of water and a 1st KOH solution were added to the first barrel of the extruder to hydrate the WPC and increase the pH to about 8 (the optimum pH for Alcalase 2.4L). The first barrel was maintained at room temperature (e.g., 20° C. to 25° C.). The protease was added to the third barrel of the extruder. As the WPC, water, 1st KOH, and the protease were mixed within the extruder, a slurry was formed and the WPC began to hydrolyze. A 2nd KOH solution was added to the fifth barrel of the extruder to increase the pH of the slurry to promote the hydrolysis of the WPC. The temperatures of the second barrel through the eleventh barrel of the extruder were maintained at approximately 60° C. The temperatures of the twelfth barrel through the fourteenth barrel were maintained at approximately 97° C. to promote inactivation of the protease. The components added to the extruder were processed within the extruder for about 2 minutes to about 5 minutes. Samples of the slurry were collected and cooled on ice for further analysis.

The feed rates for the materials added to the extruder in trial 1 are listed below in Table 1. In addition, the protease concentration, the approximate weight ratio of active protease to protein, the total solids content of the slurry exiting the extruder, the protein content of the slurry, the final pH of the slurry, and the degree of hydrolysis (DH) of the protein hydrolysate in the slurry are shown in Table 1.

TABLE 1

| | | | | Protease | Active | | | Total | Protein | | |
|---|---|---|---|---|---|---|---|---|---|---|---|
| | WPC | Water | Protease | Concentration | Protease to | 1st KOH | 2nd KOH | Solids | Content | Final | DH |
| Trial | (lb/hr) | (lb/hr) | (lb/hr) | (%) | Protein Ratio | (lb/hr) | (lb/hr) | (%) | (%)⁺ | pH | (%) |
| 1 | 12 | 6 | 3.17 | 37 | 3.33:100 | 2.56 | 3.84 | 49 | 63 | 6.75 | 8 |

⁺Protein content (%) based on weight of total solids.

The protease concentration listed in Table 1 is derived by dividing the protease feed rate by the amount of protein fed into the extruder. For example, in trial 1, the protease feed rate was 3.17 lb/hr and the feed rate of the WPC was 12 lb/hr. However, the solids content of the WPC is about 94% and about 76% by weight of the solids content of the WPC is protein, so the amount of protein fed into the extruder was about 8.6 lb/hr. Thus, dividing the protease feed rate (3.17 lb/hr) by the protein feed rate (8.6 lb/hr) gives a protease concentration of about 37%.

The active protease to protein ratio is similar to the protease concentration, but considers only the active protease being fed into the extruder. As mentioned above, Alcalase 2.4L contains about 9% active protease by weight. Accordingly, the weight ratio of active protease to protein can be determined by multiplying the protease concentration by the weight percentage of active protease. In trial 1, for example, multiplying the protease concentration (37%) by the weight percentage of active protease (9%) gives a weight ratio of active protease to protein of 3.33:100.

As seen in Table 1, a protein hydrolysate slurry with a solids content of about 49% and a DH of about 8% was produced in trial 1.

Trials 2-4—The particular equipment set up used to conduct trials 2 through 4 is illustrated schematically in FIG. 2. In trials 2 through 4, a whey protein concentrate (WPC) powder containing about 6% moisture by weight of the powder and about 76% protein by weight of the solids content of the powder was used as the intact protein source. The protease component used in trials 2 through 4 was Aclalase 2.4L (Novozyme A/S, Bagsvaerd, Denmark), which is a liquid product that contains about 9% active protease by weight of the liquid. Water and 1N KOH solutions were also used in trials 2 through 4.

In trials 2 through 4, the WPC powder and a mixture of water and protease were added to the first barrel of the extruder to hydrate the WPC and to increase the amount of time that the WPC and the protease were in contact. The first barrel was maintained at room temperature (e.g., 20° C. to 25° C.). A 1st KOH solution was added to the second barrel of the extruder to increase the pH of the contents of the extruder. As the WPC, water, protease, and 1st KOH solution were mixed within the extruder, a slurry was formed and the WPC began to hydrolyze. A 2nd KOH solution was added to the fifth barrel of the extruder to increase the pH of the slurry to promote the hydrolysis of the WPC. The temperatures of the second barrel through the eleventh barrel of the extruder were maintained at approximately 60° C. The temperatures of the twelfth barrel through the fourteenth barrel were maintained at approximately 97° C. to 100° C. to promote inactivation of the protease. The components added to the extruder in trials 2 through 4 were processed within the extruder for about 2 minutes to about 5 minutes. Samples of the slurry were collected and cooled on ice for further analysis.

The feed rates for the materials added to the extruder in trials 2 through 4 are listed below in Table 2. In addition, the protease concentration, the approximate weight ratio of active protease to protein, the total solids content of the slurry exiting the extruder, the protein content of the slurry, the final pH of the slurry, and the degree of hydrolysis (DH) of the protein hydrolysate in the slurry are shown in Table 2.

TABLE 2

| | | | | Protease | Active | | | Water mixed | Total | Protein | | |
|---|---|---|---|---|---|---|---|---|---|---|---|---|
| | WPC | Water | Protease | Conc. | Protease to | 1st KOH | 2nd KOH | with 2nd KOH | Solids | Content | Final | DH |
| Trial | (lb/hr) | (lb/hr) | (lb/hr) | (%) | Protein Ratio | (lb/hr) | (lb/hr) | (lb/hr) | (%) | (%)⁺ | pH | (%) |
| 2 | 13.5 | 13.5 | 3.56 | 37 | 3.33:100 | 2.88 | 4.32 | 4.32 | 36 | 63 | 6.99 | 15 |
| 3 | 19.3 | 13.75 | 5.08 | 37 | 3.33:100 | 4.10 | 6.16 | 6.16 | 40 | 63 | 6.99 | 14 |
| 4 | 19.3 | 13.75 | 5.08 | 37 | 3.33:100 | 4.10 | 6.16 | 6.16 | 40 | 63 | 8 | 10 |

⁺Protein content (%) based on weight of total solids.

The protease concentration and active protease to protein ratio in Table 2 are determined in same manner described above for trial 1. As seen in Table 2, protein hydrolysate slurries were produced with a solids content of from about 36% to about 40% and a DH of about 10% to about 15%.

Trials 5-8—The particular equipment set up used to conduct trials 5 through 8 is illustrated schematically in FIG. 3. In trials 5 through 8, a whey protein concentrate (WPC) powder containing about 5% moisture by weight of the powder and about 33% protein by weight of the solids content of the powder was used as the intact protein source. The protease component used in trials 5 through 8 was Aclalase 2.4L (Novozyme A/S, Bagsvaerd, Denmark). Water and 1N KOH solutions were also used in trials 5 through 8.

In trials 5 through 8, the WPC powder and a mixture of water and protease were added to the first barrel of the extruder to hydrate the WPC and to increase the amount of time that the WPC and the protease were in contact. The first barrel was maintained at room temperature (e.g., 20° C. to 25° C.). A 1st KOH solution was added to the second barrel of the extruder to increase the pH of the contents of the extruder. As the WPC, water, protease, and 1st KOH solution were mixed within the extruder, a slurry was formed and the WPC began to hydrolyze. A 2nd KOH solution was added to the fourth barrel of the extruder to increase the pH of the slurry to promote the hydrolysis of the WPC. The temperatures of the second barrel through the eleventh barrel of the extruder were maintained at approximately 60° C. The temperatures of the twelfth barrel through the fourteenth barrel were maintained at approximately 97° C. to 100° C. to promote inactivation of the protease. The components added to the extruder in trials 5 through 8 were processed within the extruder for about 2 minutes to about 5 minutes. Samples of the slurry were collected and cooled on ice for further analysis.

The feed rates for the materials added to the extruder in trials 5 through 8 are listed below in Table 3. In addition, the protease concentration, the approximate weight ratio of active protease to protein, the total solids content of the slurry exiting the extruder, the protein content of the slurry, the final pH of the slurry, and the degree of hydrolysis (DH) of the protein hydrolysate in the slurry are shown in Table 3.

TABLE 3

| | | | | Protease | Active | | | Water mixed | Total | Protein | | |
|---|---|---|---|---|---|---|---|---|---|---|---|---|
| | WPC | Water | Protease | Conc. | Protease to | 1st KOH | 2nd KOH | with 2nd KOH | Solids | Content | Final | DH |
| Trial | (lb/hr) | (lb/hr) | (lb/hr) | (%) | Protein Ratio | (lb/hr) | (lb/hr) | (lb/hr) | (%) | (%)⁺ | pH | (%) |
| 5 | 19.8 | 16.2 | 1.96 | 32 | 2.88:100 | 4.46 | 4.46 | 4.46 | 40 | 30 | 6.85 | 17 |
| 6 | 19.8 | 16.2 | 1.57 | 25 | 2.25:100 | 4.46 | 4.46 | 4.46 | 40 | 31 | 6.93 | 16.6 |
| 7 | 19.8 | 16.2 | 1.18 | 19 | 1.71:100 | 4.46 | 4.46 | 4.46 | 40 | 31 | 7.02 | 18.2 |
| 8 | 33 | 3 | 3.27 | 32 | 2.88:100 | 7.43 | 7.43 | 1.49 | 61 | 30 | 7.08 | 18.3 |

⁺Protein content (%) based on weight of total solids.

The protease concentration and active protease to protein ratio in Table 3 were determined in same manner described above for trial 1. As seen in Table 3, protein hydrolysate slurries were produced with a solids content of from about 40% to about 61% and a DH of about 17% to about 18.3%.

Trials 9 and 10—The particular equipment set up used to conduct trials 9 and 10 was the same as for trials 5 through 8 and is illustrated schematically in FIG. 3. In trials 9 and 10, a whey protein concentrate (WPC) powder containing about 6% moisture by weight of the powder and about 76% protein by weight of the solids content of the powder was used as the intact protein source. The protease component used in trials 9 and 10 was Aclalase 2.4L (Novozyme A/S, Bagsvaerd, Denmark). Water and 1N KOH solutions were also used in trials 9 and 10.

In trials 9 and 10, the WPC powder and a mixture of water and protease were added to the first barrel of the extruder to hydrate the WPC and to increase the amount of time that the WPC and the protease were in contact. The first barrel was maintained at room temperature (e.g., 20° C. to 25° C.). A 1st KOH solution was added to the second barrel of the extruder to increase the pH of the contents of the extruder. As the WPC, water, protease, and 1st KOH solution were mixed within the extruder, a slurry was formed and the WPC began to hydrolyze. A 2nd KOH solution was added to the fourth barrel of the extruder to increase the pH of the slurry to promote the hydrolysis of the WPC. The temperatures of the second barrel through the eleventh barrel of the extruder were maintained at approximately 60° C. The temperatures of the twelfth barrel through the fourteenth barrel were maintained at approximately 97° C. to 100° C. to promote inactivation of the protease. The components added to the extruder in trials 9 and 10 were processed within the extruder for about 2 minutes to about 5 minutes. Samples of the slurry were collected and cooled on ice for further analysis.

The feed rates for the materials added to the extruder in trials 9 and 10 are listed below in Table 4. In addition, the protease concentration, the approximate weight ratio of active protease to protein, the total solids content of the slurry exiting the extruder, the protein content of the slurry, the final pH of the slurry, and the degree of hydrolysis (DH) of the protein hydrolysate in the slurry are shown in Table 4.

TABLE 4

| | | | | Protease | Active | | | Water mixed | Total | Protein | | |
|---|---|---|---|---|---|---|---|---|---|---|---|---|
| | WPC | Water | Protease | Conc. | Protease to | 1st KOH | 2nd KOH | with 2nd KOH | Solids | Content | Final | DH |
| Trial | (lb/hr) | (lb/hr) | (lb/hr) | (%) | Protein Ratio | (lb/hr) | (lb/hr) | (lb/hr) | (%) | (%)⁺ | pH | (%) |
| 9 | 19.3 | 13.75 | 5.08 | 37 | 3.33:100 | 4.10 | 11.55 | 1.155 | 40 | 63 | 7.38 | 16 |
| 10 | 19.3 | 13.75 | 3.05 | 22 | 1.98:100 | 4.10 | 11.55 | 1.155 | 39 | 66 | 7.63 | 13 |

⁺Protein content (%) based on weight of total solids.

The protease concentration and the active protease to protein ratio in Table 4 were determined in same manner as described above for trial 1. As seen in Table 4, protein hydrolysate slurries were produced with a solids content of about 39% to about 40% and a DH of about 13% to about 16%.

The molecular weight profile for the protein hydrolysate slurries prepared in accordance with trials 1 through 10 as described above are shown below in Table 5. The molecular weight profiles were determined using a high performance size exclusion chromatography with UV detection (HPSEC/UV) method as described in Johns et al., “Characterization of peptide molecular mass distribution in commercial hydrolysates and hydrolysate-based nutritional products,” Food Chemistry (2011), Vol. 125, pp. 1041-1050, which is incorporated herein by reference in its entirety.

TABLE 5

| | Molecular Weight Ranges | | | | |
|---|---|---|---|---|---|
| | >5,000 | 3,000-5,000 | 1,000-3,000 | 500-1,000 | <500 |
| Trial | (%) | (%) | (%) | (%) | (%) |
| 1 | 44 | 12.7 | 28.3 | 8.4 | 6.6 |
| 2 | 16.4 | 11.4 | 37.3 | 18.8 | 16.1 |
| 3 | 15.6 | 12 | 38.8 | 18 | 15.6 |
| 4 | 34.5 | 13.7 | 33.5 | 10.8 | 7.7 |
| 5 | 10.9 | 8.8 | 40.1 | 21.1 | 19.1 |
| 6 | 12.3 | 8.9 | 39.3 | 20.3 | 19.2 |
| 7 | 6.1 | 8.7 | 41.9 | 22.2 | 21.1 |
| 8 | 8.2 | 8.7 | 38.8 | 22.7 | 21.6 |
| 9 | 13.5 | 9.7 | 39.2 | 20 | 17.6 |
| 10 | 23.2 | 11.5 | 36 | 16.2 | 13.1 |

To the extent that the term “includes” or “including” is used in the specification or the claims, it is intended to be inclusive in a manner similar to the term “comprising” as that term is interpreted when employed as a transitional word in a claim. Furthermore, to the extent that the term “or” is employed (e.g., A or B) it is intended to mean “A or B or both.” When the applicants intend to indicate “only A or B but not both” then the term “only A or B but not both” will be employed. Thus, use of the term “or” herein is the inclusive, and not the exclusive use.

While the present application has been illustrated by the description of embodiments thereof, and while the embodiments have been described in considerable detail, it is not the intention of the Applicant to restrict or in any way limit the scope of the appended claims to such detail. Additional advantages and modifications will readily appear to those skilled in the art. Therefore, the application, in its broader aspects, is not limited to the specific details, the representative compositions or formulations, and illustrative examples shown and described. Accordingly, departures may be made from such details without departing from the spirit or scope of the general disclosure described herein.

1. A method of preparing a protein hydrolysate comprising:
adding an intact protein source and a protease component to an extruder; and
mixing the intact protein source and the protease component within the extruder to form a slurry comprising a protein hydrolysate having a degree of hydrolysis of 5% to 30%;
wherein the slurry has a total protein content of at least 30% based on the weight of solids in the slurry.

2. The method of claim 1, further comprising adding a pH adjuster to the extruder to maintain a pH of the slurry at from 5 to 9.

3. The method of claim 1, further comprising adding water to the extruder.

4. The method of claim 1, further comprising heating the contents of the extruder to a temperature of from 20° C. to 75° C.

5. The method of claim 1, further comprising heating the slurry to a temperature of from 80° C. to 105° C. to promote inactivation of the protease component.

6. The method of claim 1, wherein the slurry comprises from 30% to 70% by weight solids.

7. The method of claim 1, wherein the intact protein source and the protease component are added to the extruder in amounts such that a weight ratio of active protease to protein is from 0.8:100 to 8:100.

8. The method of claim 1, wherein the protease component comprises a protease derived from Bacillus licheniformis.

9. The method of claim 1, wherein the protease component comprises a protease derived from Aspergillus oryzae.

10. The method of claim 1, wherein the protease component comprises a mixture of proteases.

11. The method of claim 1, wherein the intact protein source is in powder form.

12. The method of claim 1, wherein the intact protein source comprises a dairy protein, and wherein the slurry has a total protein content of from 30% to 90% based on the weight of solids in the slurry.

13. The method of claim 12, wherein the dairy protein is selected from the group consisting of whey protein concentrate, whey protein isolate, acid casein, rennet casein, sodium caseinate, calcium caseinate, potassium caseinate, milk protein concentrate, milk protein isolate, non-fat dry milk, and combinations thereof.

14. The method of claim 1, wherein the intact protein source comprises a non-dairy protein, and wherein the slurry has a total protein content of from 40% to 85% based on the weight of solids in the slurry.

15. The method of claim 14, wherein the non-dairy protein is selected from the group consisting of soy protein concentrate, soy protein isolate, pea protein concentrate, pea protein isolate, rice protein concentrate, rice protein isolate, potato protein concentrate, potato protein isolate, algal protein concentrate, algal protein isolate, corn protein concentrate, corn protein isolate, wheat protein concentrate, wheat protein isolate, oat protein concentrate, oat protein isolate, canola protein concentrate, canola protein isolate, sunflower protein concentrate, sunflower protein isolate, soy flour, peanut flour, and combinations thereof.

16. A protein hydrolysate prepared according to the method of claim 1.

17. A method of preparing a protein hydrolysate comprising:
adding an intact protein source in powder form into one or more inlets of an extruder;
adding a protease component into one or more inlets of the extruder;
adding water into one or more inlets of the extruder;
adding a pH adjuster into one or more inlets of the extruder; and
mixing the intact protein source, the protease component, water, and the pH adjuster within the extruder to form a slurry comprising a protein hydrolysate having a degree of hydrolysis of 5% to 30%;
wherein the slurry has a total protein content of at least 30% based on the weight of solids in the slurry.

18. The method of claim 17, wherein the intact protein source, the protease component, water, and the pH adjuster are mixed within the extruder at a temperature of from 20° C. to 75° C.

19. The method of claim 17 or claim 18, further comprising heating the slurry to a temperature of from 80° C. to 105° C. to promote inactivation of the protease component.

20. The method of claim 17, wherein the intact protein source and the protease component are added to the extruder in amounts such that a weight ratio of active protease to protein is from 0.8:100 to 8:100.

21.-29. (canceled)
